(19) United States
(12) Patent Application Publication
(10) Pub. No.: US 2012/0298459 A1
(43) Pub. Date: Nov. 29, 2012

(54) Dynamic Electric Brake for Movable Articles

(76) Inventors: David P. Lubbers, Cincinnati, OH (US); David A. Albersmeyer, Hoagland, IN (US); Gregory A. Meyer, Batesville, IN (US); Jerome E. Reckelhoff, Blue Ash, OH (US); Dale J. Struewing, Batesville, IN (US)

(21) Appl. No.: 13/569,026

(22) Filed: Aug. 7, 2012

Related U.S. Application Data
(63) Continuation of application No. 12/436,588, filed on May 6, 2009.

(51) Int. Cl. B60L 7/00

(52) U.S. Cl. 188/159

(57) ABSTRACT

An occupant support 30 includes a frame 32, at least one rolling element 44 enabling the frame to be rolled from an origin to a destination and a brake command generator 60 adapted to generate a brake command 62. An electromachine 66 produces an output 68 in response to the brake command for decelerating the rolling element.

This is a continuation of U.S. application Ser. No. 12/436,588 entitled “Dynamic Electric Brake for Movable Articles” filed on May 6, 2009, the contents of which are incorporated herein by reference.

### TECHNICAL FIELD

The subject matter described herein relates to movable articles such as hospital beds and particularly to a movable article having a dynamic electric brake for decelerating the article.

### BACKGROUND

Occupant supports such as hospital beds are frequently outfitted with wheels or casters to make the bed mobile. Although some beds may be equipped with a propulsion unit, many beds must be moved manually. Because hospital beds are heavy it may not be possible for the person moving the bed to stop it quickly, for example to avoid a pedestrian. Hospital beds are often equipped with static brakes, but such brakes are not intended to decelerate a moving bed. Instead, they are merely latches for immobilizing the casters when the bed is stationary and intended to remain stationary. Moreover, static brakes are conventionally operated by foot pedals not intended to be operated by a person moving the bed.

### SUMMARY

An occupant support disclosed herein includes a frame, at least one rolling element enabling the frame to be rolled from an origin to a destination, a brake command generator adapted to generate a brake command and an electromachine capable of producing an output in response to the brake command for decelerating the rolling element.

The foregoing and other features of the various embodiments of the occupant support described herein will become more apparent from the following detailed description and the accompanying drawings.

### BRIEF DESCRIPTION OF THE DRAWINGS

FIG. 1 is a schematic, side elevation view of a hospital bed.

FIG. 2 is an enlarged view of a variant of a handgrip portion of the bed of FIG. 1.

FIG. 3 is an enlarged view of another variant of the handgrip portion of the bed of FIG. 1.

FIG. 4 is a block diagram depicting a basic configuration of a dynamic electric braking system for the bed of FIG. 1.

FIG. 5 is a block diagram similar to FIG. 4 showing the braking system enhanced by the presence of a battery and a controller.

FIGS. 6A & 6B are schematic views of a braking effector in the form of a brake shoe.

FIGS. 7A & 7B are schematic views of a braking effector in the form of a brake shoe and also showing a spring mediating between the brake shoe and the output of a motor.

FIGS. 8A & 8B are schematic views showing a braking effector in the form of a brake shoe and also showing a load cell for determining braking force.

FIG. 9 is a schematic view of a braking effector in the form of a caliper.

FIG. 10 is a view similar to FIG. 5 in which a brake command generator is represented as a simple electrical switch.

FIG. 11 is a view similar to FIG. 10 showing a feedback path extending between a controller and a component mechanically downstream of a motor.

FIGS. 12-15 are deceleration schedules described in the context of FIG. 11 but also useable in other configurations of a dynamic braking system.

FIG. 16 is a block diagram depicting a braking system in which a brake command generator produces a non-discrete brake command.

FIG. 17 is a sample relationship between physical position of a brake actuator and the magnitude of a braking force or the magnitude of a braking request received by a controller.

FIG. 18 is a block diagram depicting a braking system using an electrical generator.

FIG. 19 is a block diagram similar to FIG. 18 in which a brake command generator is represented as a simple electrical switch which may be included as part of the handgrip of FIG. 2.

FIG. 20 is a block diagram similar to FIG. 18 in which a controller includes a predefined, open loop deceleration schedule of electrical load as a function of time.

FIG. 21 is a sample schedule of electrical load as a function of time described in the context of FIG. 20 but also useable in other configurations of a dynamic braking system.

FIG. 22 is a block diagram similar to FIG. 20 but also including a feedback path 88 to a controller to allow closed loop control of bed deceleration.

FIG. 23 depicts a sample control schedule of resistive load as a function of bed speed or deceleration described in the context of FIG. 22 but also useable in other configurations of a dynamic braking system.

FIG. 24 is a block diagram similar to FIG. 22 showing a feedback path extending from the generator to the controller.

FIG. 25 is a deceleration schedule of resistive load as a function of generator output voltage described in the context of FIG. 24 but also useable in other configurations of a dynamic braking system.

FIG. 26 is a block diagram describing a pulse width modulated braking system in which a brake command generator produces a non-discrete brake command.

FIG. 27 is a schedule of pulse width modulation duty cycle as a function of physical position of the brake actuator described in the context of FIG. 26.

FIG. 28 is a block diagram similar to FIG. 20 in which the output of a brake command generator is a non-discrete output.

FIG. 29 is a sample relationship between physical position of a brake actuator such as the handgrip trigger of FIG. 2 or the lever of FIG. 3 and the magnitude of a brake command.

### DETAILED DESCRIPTION

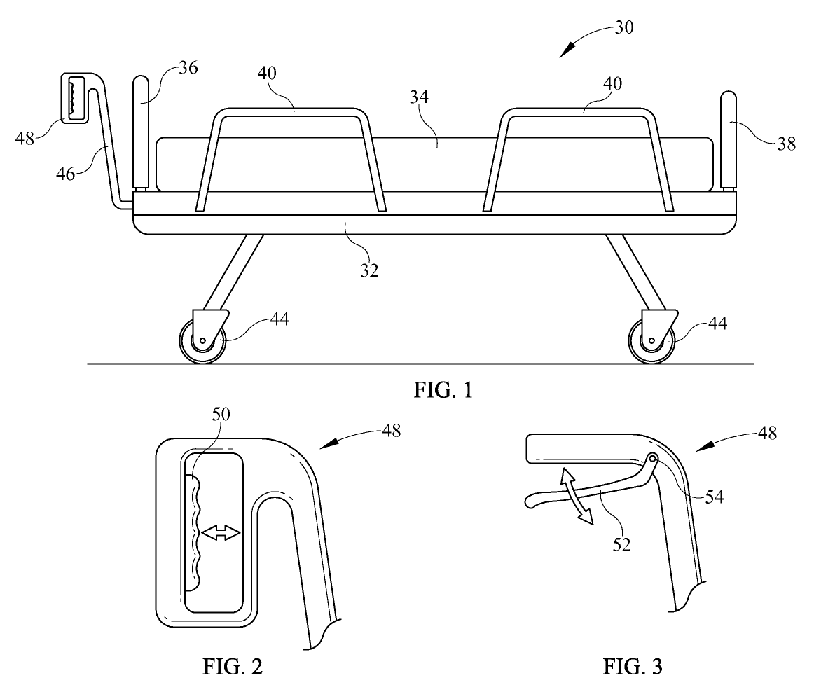

Referring to FIG. 1, an occupant support represented by hospital bed 30 includes a frame 32, a mattress 34, a headboard 36, a footboard 38 and siderails 40. Rolling elements such as wheels or a set of casters 44, one near each corner of the frame, impart mobility to the frame, and therefore to the bed as a whole, allowing a person to roll the bed from an origin to a destination. A handle 46 extends from the frame to a handgrip 48. The handgrip may be of any suitable configuration. One example is the loop handgrip of FIG. 2. The loop handgrip includes a trigger 50 which, when squeezed by a human operator, recedes partly into the handgrip. When the operator releases the trigger it returns to its original position under the influence of a spring, not shown. Another example is the handlebar style handgrip of FIG. 3. The handlebar handgrip includes a lever 52 mounted on the handle and rotatable about axis 54 when squeezed by a human operator. When the operator releases the lever it returns to its original position under the influence of a spring, not shown Features such as the trigger and lever may be referred to herein collectively as an actuator.

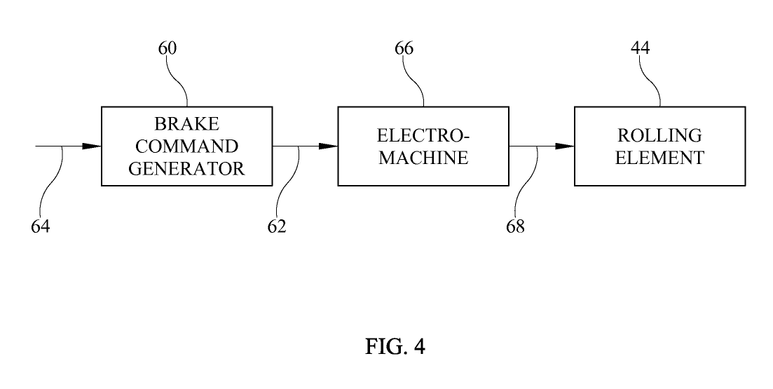

FIG. 4 shows the basic configuration of a dynamic electric braking system. The braking system includes a brake command generator 60 for generating a brake command 62 in response to an operator input. The command generator includes the actuator 50, 52. Movement of the actuator signifies the operator's intention to decelerate a moving bed. The braking system also includes an electromachine 66, for example an electric motor or electric generator capable of producing an output 68 responsive to the brake command for decelerating the rolling element 44.

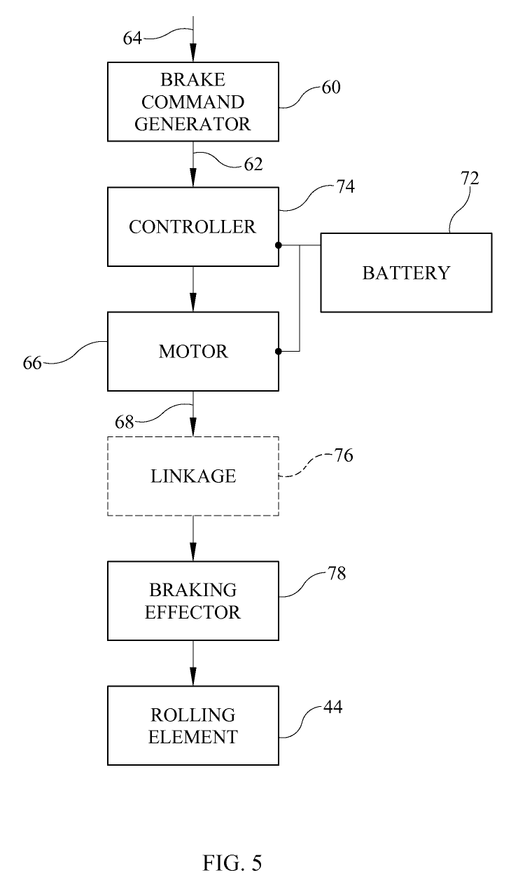

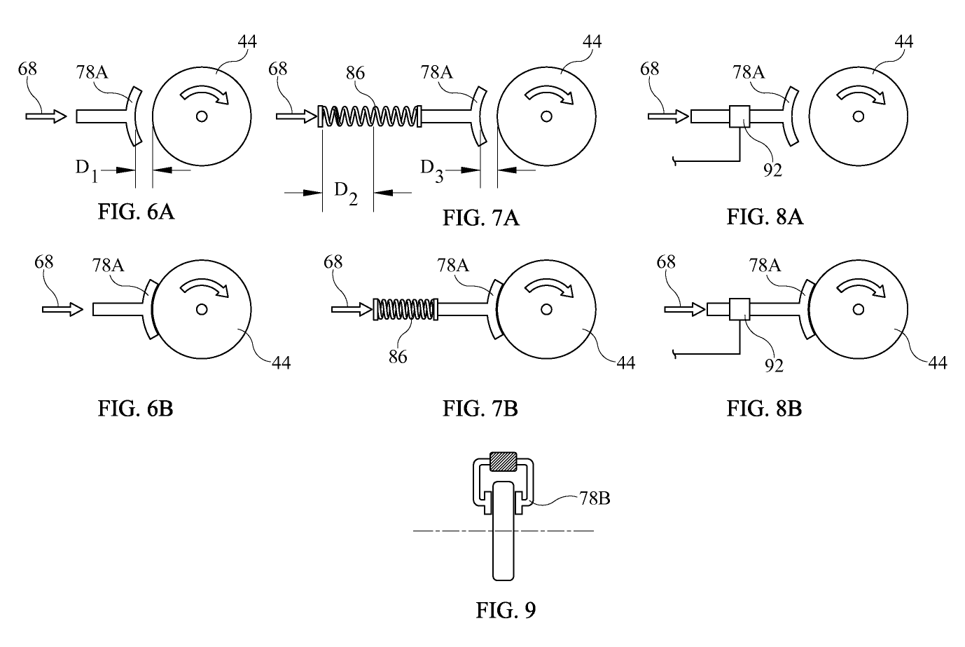

FIG. 5 shows a version of the system of FIG. 4 enhanced by the presence of a battery 72 and a controller 74 (e.g. a microprocessor powered by the battery) in communication with the brake command generator and the electromachine. FIG. 5 also shows the electromachine as a motor 66 powered by the battery. FIG. 5 also shows the output 68 of the motor acting on a linkage 76 which, in turn, acts on a braking effector 78. Alternatively, the motor output 68 may act directly on the braking effector. The braking effector may take on any suitable form, for example a brake shoe 78A that contacts a brake drum or the casters themselves (FIGS. 6-8) or a caliper 78B that contacts a brake disk or the flanks of the casters (FIG. 9). Brake linings, not illustrated, may be applied to one or both of the contacting components if desired. Irrespective of the form of the braking effector, it is responsive, directly or indirectly, to the output of the electromachine to effect the desired deceleration of the bed. The braking effector may operate on only one of the four casters typically found on hospital beds, or there may be more than one effector, each dedicated to one caster.

To decelerate a moving bed, an operator activates the brake command generator 60, for example by squeezing the trigger of FIG. 2 or the lever of FIG. 3, thereby issuing a brake command 62 to operate the motor. The rotation of the motor shaft moves the linkage, if present, or moves the braking effector directly to cause the braking effector to decelerate the casters, and therefore the bed as a whole. The operator may decelerate the bed to a complete stop or merely bring it to a slower speed.

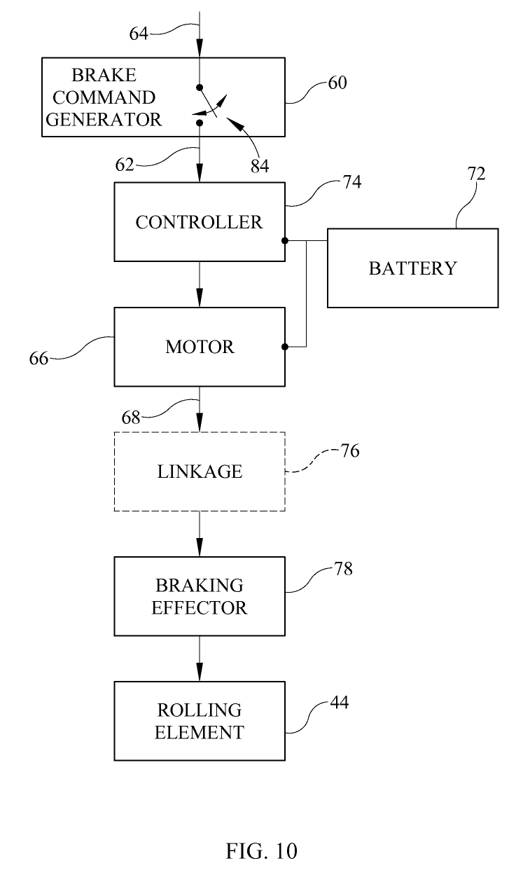

FIG. 10 shows a simple arrangement in which the brake command generator 60 is represented as a simple electrical switch 84 which may be included as part of the handgrip. Because the switch has only two states, open and closed, the output of the brake command generator is a discrete brake command. The switch is normally open. An operator closes the switch by way of the actuator. This signals the controller to supply power to the motor to operate the braking effector as already described.

Referring additionally to FIGS. 6-7 in conjunction with FIG. 10, certain particulars of how the braking components may be configured can now be better appreciated. In FIGS. 6A and 6B, there is a fixed kinematic relationship between the motor output and the response of the braking effector as represented by brake shoe 78A. Specifically, the system moves the brake shoe a fixed distance D1 in response to the motor output. Such an arrangement is mechanically simple but will result in diminished braking force as a result of shoe and or drum wear. In FIGS. 7A and 7B a spring 86 or other purposefully elastic element mediates between the motor output 68 and the brake shoe. The motor causes a displacement D2 at the input side of the spring which results in a displacement D3 of the brake shoe. Until the shoe contacts the drum, D3 equals D2. After the shoe contacts the drum any additional displacement D2 compresses the spring by an amount D2-D3 thereby urging the shoe more forcibly against the drum. As the shoe and/or drum wear, the braking force diminishes. However the presence of the spring allows the designer to design excess displacement D2 into the system to prolong the useful life of the shoe and/or drum. An elastic element can be similarly used in a disk brake system (FIG. 9) to mediate between the motor and the caliper.

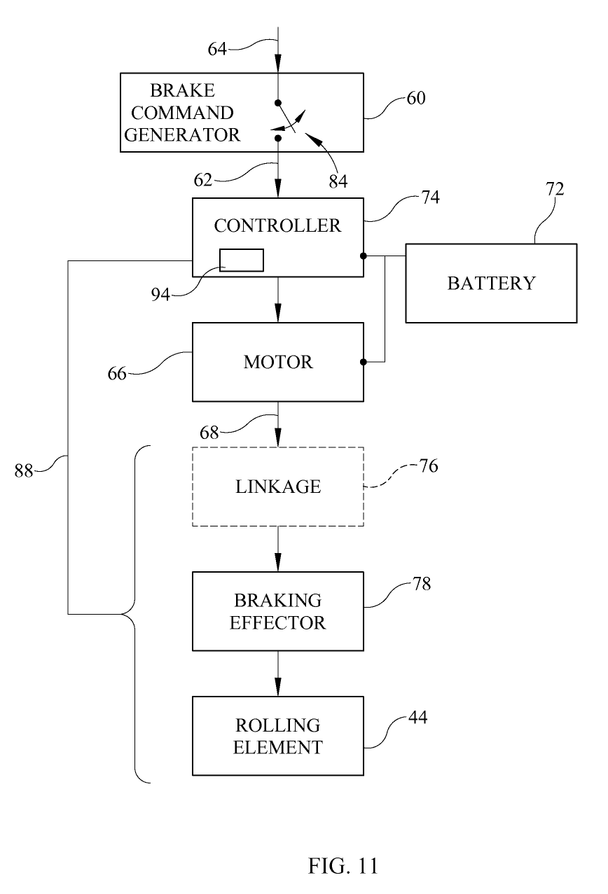

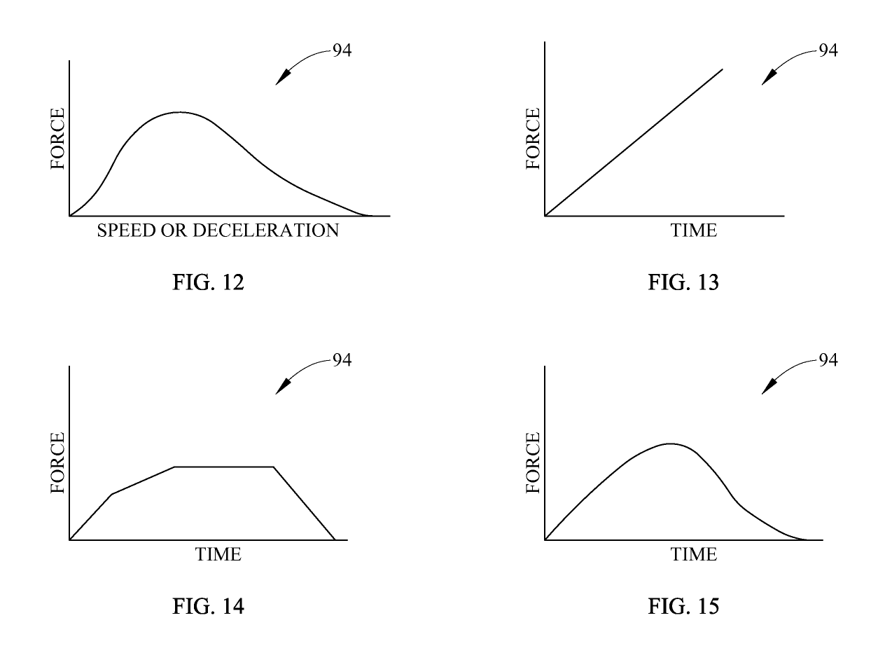

FIG. 11 shows an arrangement similar to that of FIG. 10 but with a feedback path 88 extending from one of the components mechanically downstream of the motor to the controller. Referring additionally to FIG. 8, such a system may include a load cell 92 to monitor the force applied to the drum by shoe 78A. The magnitude of the force is fed back to the controller by way of the feedback path 88. The controller includes a predefined deceleration schedule 94 which schedules or governs the deceleration, typically as a function of an independent variable. Such a schedule may simply specify a constant force, in which case the controller causes the motor to continually adjust the displacement of the brake shoe to achieve the scheduled constant braking force. As seen in FIG. 12 another possible deceleration schedule is one that varies the braking force as a function of the speed or deceleration of the bed. As seen in FIGS. 13-15 other possible deceleration schedules specify the braking force as a function of time. FIGS. 13-15 show, by way of example only, linear, piecewise linear and nonlinear time-based deceleration schedules.

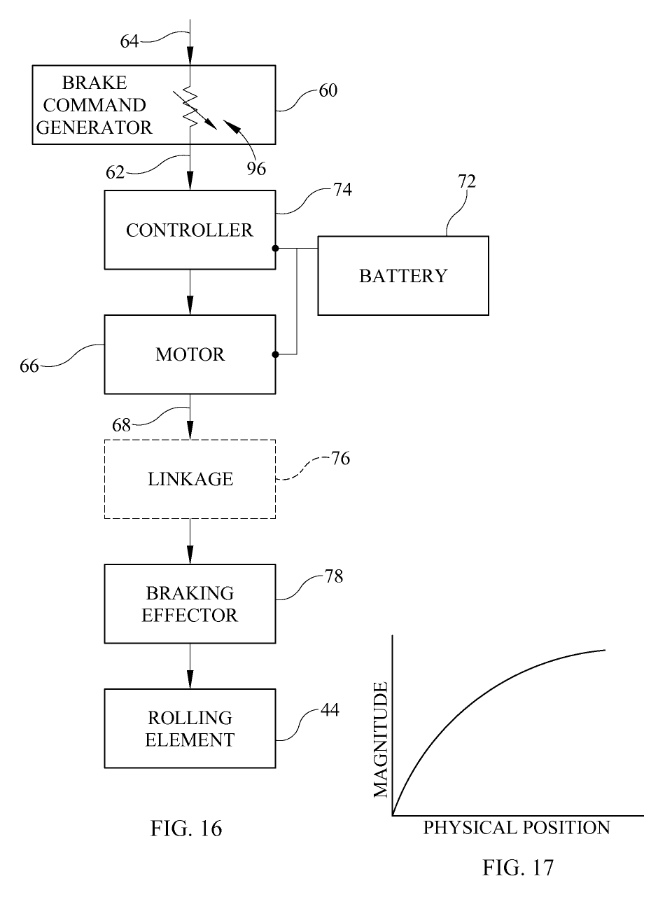

FIG. 16 illustrates an arrangement in which the brake command generator produces a non-discrete brake command. The arrangement includes a variable resistor 96 responsive to the physical position of the actuator. The physical position of the actuator governs the resistance of the variable resistor, which is reflected in the brake command 62 issued to the controller. Typically the system will be configured so that increased displacement of the actuator results in increased braking force. FIG. 17 shows a sample relationship between physical position of the trigger or lever and the magnitude of the braking force. Alternatively, FIG. 17 can be interpreted as the magnitude of the request received by the controller. The relationship may be linear or nonlinear.

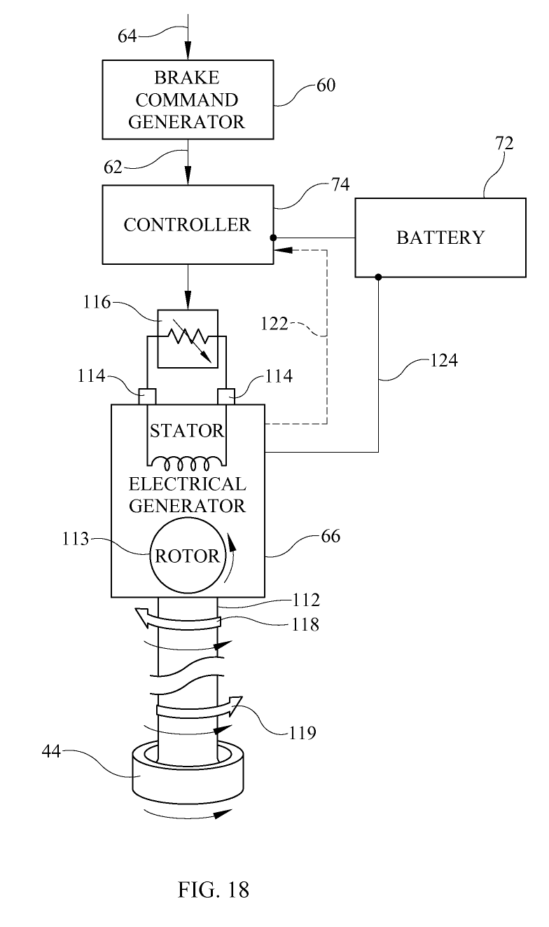

FIG. 18 shows an arrangement in which the electromachine is a generator 66 having a rotatable input shaft 112 connected to or integral with generator rotor 113. When the bed is in motion, rotation of the casters rotates the generator input shaft and rotor thereby generating a voltage across terminals 114. The arrangement also includes a variable resistance 116 connected across the terminals. The controller 74 regulates the magnitude of the resistance 116 in response to a command issued by the brake command generator 66. When braking is not requested the controller opens the circuit between terminals 114. As a result, no current flows in the circuit, and so the generator offers no mechanical resistance to rotation of the casters. When the operator requests braking the controller sets resistance 116 to a value commensurate with the magnitude of the brake command 62. For example a low electrical resistance allows a high current in the stator windings, which strongly resists rotation of the rotor; a higher electrical resistance reduces current flow in the stator, thereby decreasing the electromechanical resistance to rotation of the rotor and allowing the casters to roll more freely. The electrical resistance causes the generator to produce an output in the form of a resistive torque 118 that counteracts the input torque 119 delivered to the generator by the casters, thereby decelerating the bed. Hence, the controller governs the speed of the rotary input by applying a resistive electrical load to the electrical generator 110.

In principle the electrical generator could power the controller by way of electrical connection 122, however the controller would receive power only while the bed was in motion. A battery 72 is used if it is desired to continuously power the controller. The generator may be connected to the battery by a connection 124 so that the generator can be used to charge the battery.

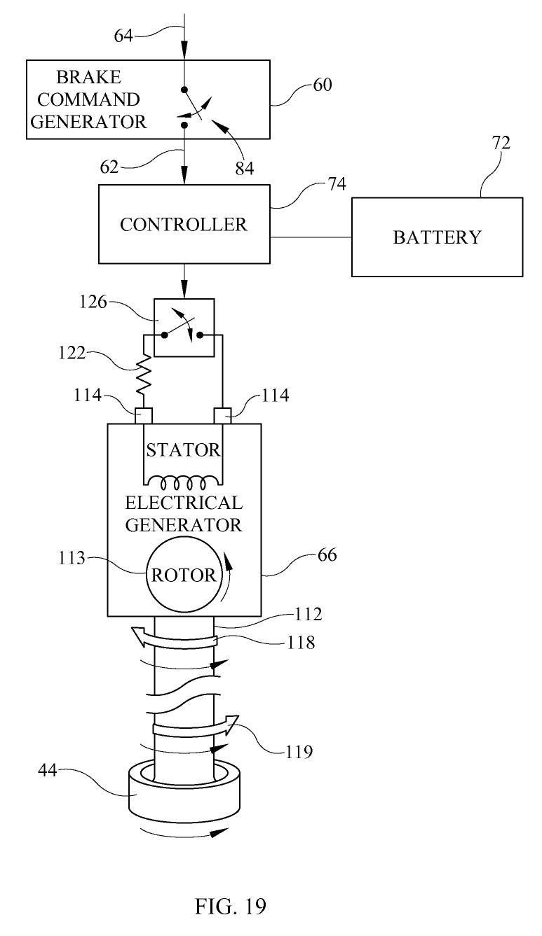

FIG. 19 shows an arrangement similar to that of FIG. 18 in which the brake command generator 60 is represented as a simple electrical switch 84 which may be included as part of the handgrip 48 (FIGS. 1-3). Because the switch has only two states, open and closed, the output of the brake command generator is a discrete brake command. The switch is normally open. An operator closes the switch by way of the trigger 50, lever 52 or other actuator. This signals the controller to apply an appropriate pre-selected resistance 122 across the generator terminals. In the illustrated embodiment the controller closes a second switch 126 to apply the resistance.

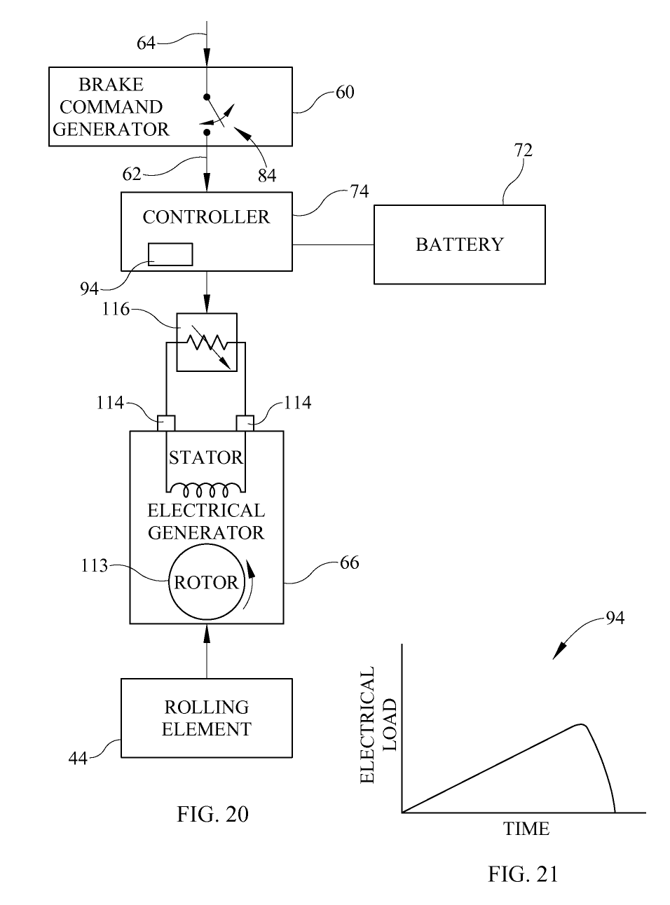

FIG. 20 shows an arrangement similar to that of FIG. 18 in which the controller includes a predefined, open loop deceleration schedule of electrical load as a function of time, such as the schedule of FIG. 21. When the controller receives a brake command 62 it varies the resistance of variable resistor 116 according to the schedule to decelerate the bed.

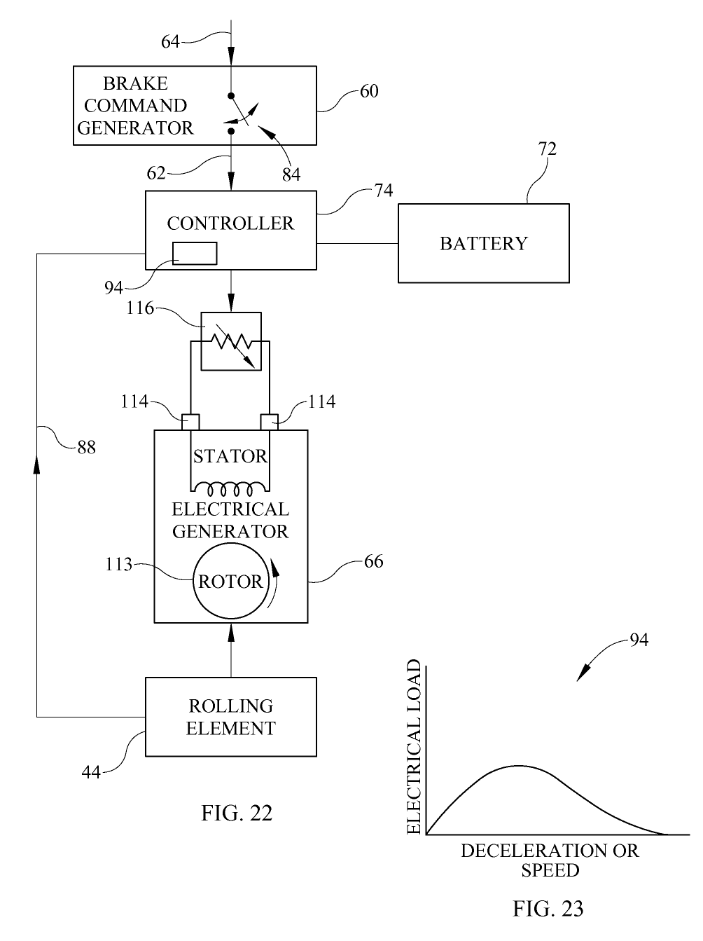

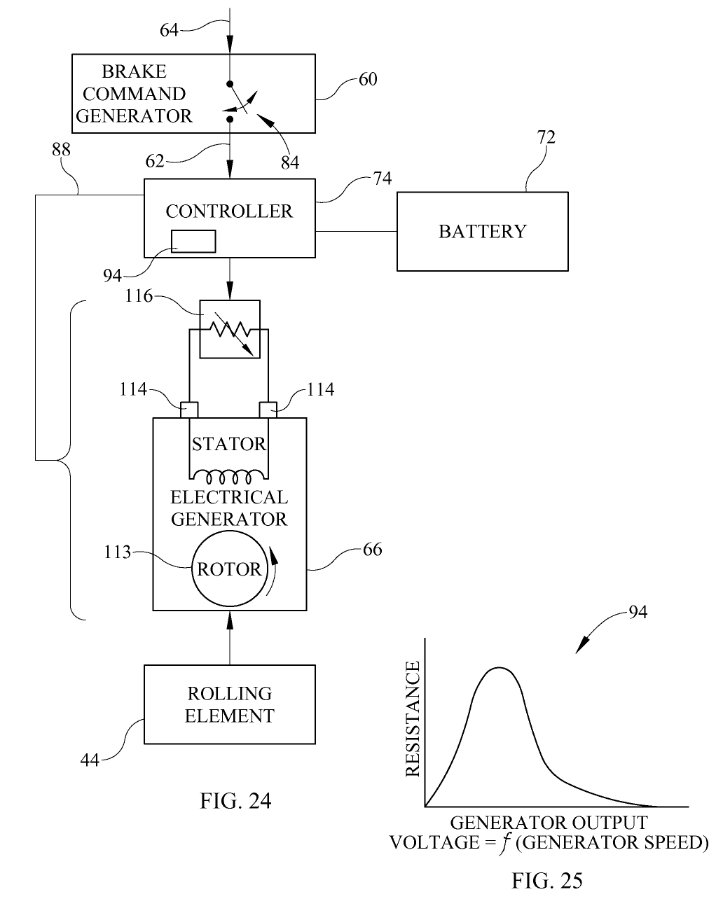

FIG. 22 shows an arrangement similar to that of FIG. 20 but also including a feedback path 88 to the controller to allow closed loop control of bed deceleration. The controller includes a control schedule 94 such as the schedule of FIG. 23 which schedules the resistive load as a function of bed speed or deceleration. Bed speed may be determined by, for example, monitoring the rotational speed of the casters as suggested by the origin of feedback path 88 in FIG. 22. Bed speed may alternatively be determined by integrating the output of an accelerometer affixed to the bed frame. FIG. 24 shows a similar arrangement in which the feedback path 88 extends from the generator to the controller, and the deceleration schedule (FIG. 25) is a schedule of resistive load as a function of generator output voltage, which is a function of speed.

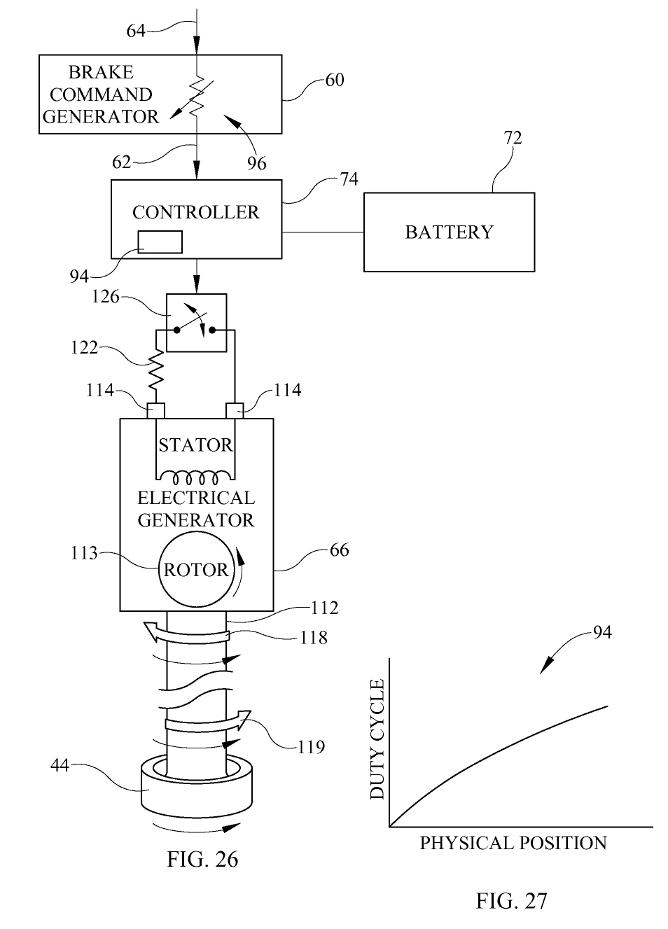

FIG. 26 illustrates a pulse width modulated (PWM) arrangement in which the brake command generator 60 produces a non-discrete brake command 62. The arrangement includes a variable resistor 96 responsive to the physical position of the handgrip trigger 50 or lever 52. The physical position of the trigger or lever governs the resistance of the variable resistor, which is reflected in the brake command 62 issued to the controller. Typically the system will be configured so that increased displacement of the trigger or lever results in increased braking force. The terminals 114 of the electrical generator 66 are connected to a fixed value resistor 122 in series with a switch 126. The controller includes a schedule 94 of pulse width modulation duty cycle (FIG. 27) as a function of physical position of the trigger 50 or lever 52. The switch 126 closes and opens in a pattern that mimics the PWM cycle. As the duty cycle increases, the switch 126 remains closed for a larger proportion of time, thereby causing the generator to experience a time averaged resistance lower than the resistance associated with an open circuit (switch 126 open) and therefore to decelerate the bed more quickly.

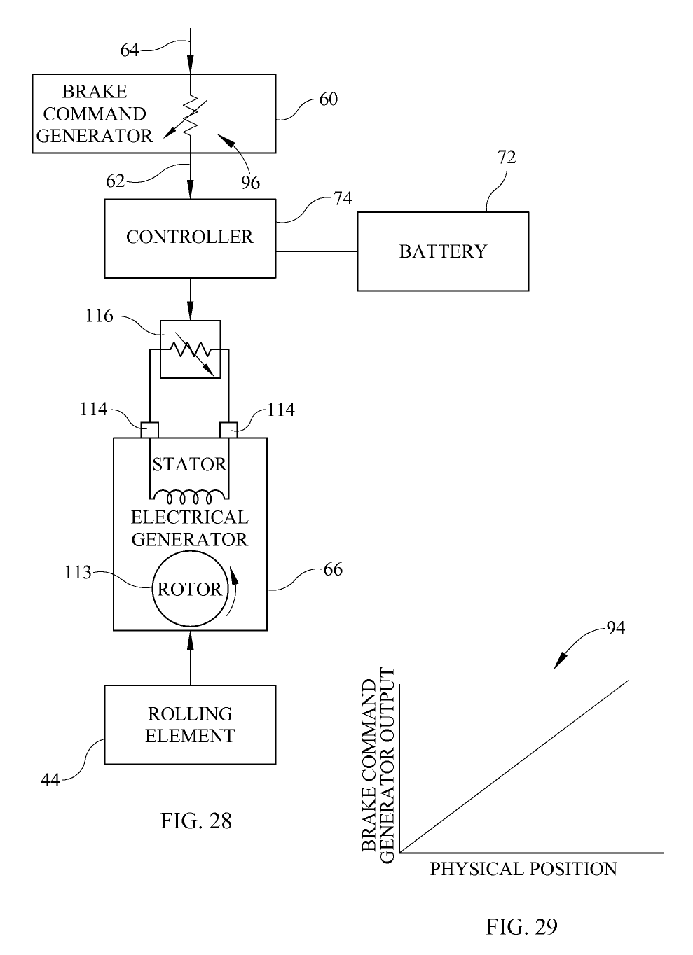

FIG. 28 shows an arrangement similar to that of FIG. 20 except that output 62 of the brake command generator is non-discrete, similar to the non-discrete commands already described in the context of FIGS. 16 and 26. The controller receives the variable braking command and, in accordance with the magnitude of the command, sets the resistance of the variable resistor 116. FIG. 29 shows an example of a relationship between physical position of the handgrip trigger or lever and the magnitude of the brake command 62.

Although this disclosure refers to specific embodiments, it will be understood by those skilled in the art that various changes in form and detail may be made without departing from the subject matter set forth in the accompanying claims.

We claim:

1. An occupant support, comprising:
a frame;
at least one rolling element enabling the frame to be rolled from an origin to a destination;
a brake command generator adapted to generate a brake command;
a controller in communication with the brake command generator; and
an electrical generator having electrical terminals and a rotary input whose source is rotary motion of the rolling element; and
wherein the controller, in response to the brake command, regulates the magnitude of an electrical load applied to the generator so that the generator produces an output for decelerating the rolling element.

2. The support of claim 1 wherein the electrical load is variable.

3. The occupant support of claim 1 in which the electrical load results from an electrical resistance across terminals of the generator, the resistance being commensurate with the brake command.

4. The occupant support of claim 1 in which the controller opens an electrical path between terminals of the generator in response to a command for no braking being generated by the brake command generator.

5. The support of claim 1 wherein the controller includes a resistive load schedule.

6. The occupant support of claim 1 including an electrical connection between the generator and the controller for powering the controller.

7. The occupant support of claim 1 including a battery to power the controller and an electrical connection between the battery and the controller.

8. The occupant support of claim 7 including an electrical connection between the generator and the battery for charging the battery.

9. The occupant support of claim 1 in which the brake command is a discrete command.

10. The occupant support of claim 1 in which the brake command is a non-discrete command.

11. The occupant support of claim 9 in which the brake command generator comprises an actuator and a first electrical switch controlled by the actuator.

12. The occupant support of claim 11 comprising a second switch between the generator terminals and in which closure of the first switch signals the controller to close the second switch.

13. The occupant support of claim 12 in which closure of the second switch applies a preselected electrical resistance across the terminals.

14. The occupant support of claim 1 including a variable resistance across the terminals of the generator and in which the controller includes a predefined, open loop deceleration schedule, and in which the controller, in response to the brake command, varies the resistance of the variable resistor according to the deceleration schedule.

15. The occupant support of claim 14 including a feedback path from the rolling element to the controller to allow closed loop control of bed deceleration.

16. The occupant support of claim 15 in which the controller includes a control schedule which schedules the variable resistance as a function of bed speed or deceleration.

17. The occupant support of claim 15 in which the controller includes a control schedule which schedules the variable resistance as a function of generator output voltage.

18. The occupant support of claim 1 in which the brake command generator comprises an actuator and a variable resistor whose resistance value is governed by the actuator; and
the controller includes a schedule of pulse width modulation duty cycle as a function of the resistance value.
